(19) United States
(12) Patent Application Publication
(10) Pub. No.: US 2019/0044419 A1
(43) Pub. Date: Feb. 7, 2019

(54) POSITION SENSOR AND MOTOR

(71) Applicant: MABUCHI MOTOR CO., LTD., Chiba (JP)

(72) Inventor: Akira MATSUNAWA, Chiba (JP)

(21) Appl. No.: 16/049,827

(22) Filed: Jul. 31, 2018

(30) Foreign Application Priority Data
Aug. 7, 2017 (JP) 2017-152399

(51) Int. Cl. H02K 11/225

(52) U.S. Cl. CPC H02K 11/225

(57) ABSTRACT

A position sensor detects the rotational position of a rotor relative to a stator, based on a change in inductance due to a rotation of the rotor fixed to a shaft. The stator is tubular and disposed concentrically with the rotation center of the shaft. The stator includes: magnetic pole pairs protruding from an inner peripheral surface toward the rotation center, and each including a pair of opposing main magnetic poles; auxiliary magnetic poles positioned on both sides of each main magnetic pole, and protruding inward from the inner peripheral surface. The rotor includes at least a pair of protruding poles protruding outward from a reference cylindrical surface at a constant distance from the rotation center. The position sensor includes coil pairs including coils wound on the main magnetic poles of the magnetic pole pairs. The two coils of each of the coil pairs have the same winding direction.

### BACKGROUND

### 1. Technical Field

The present invention relates to an inductive position sensor for detecting a rotor rotational position of a motor, and to a motor equipped with the position sensor.

### 2. Description of the Related Art

Conventionally, motors (such as brushless motors, in particular) may be provided with a detector (sensor) for detecting the rotational speed or rotation angle (rotational position) of the motor. An example of the detector is a Hall sensor which detects the rotational position of the rotor, using the magnetic flux of a permanent magnet in the rotor of the motor (see Japanese Patent No. 2639521, for example). In a brushless motor equipped with a Hall sensor, the rotational position of the rotor is identified based on an output signal from the Hall sensor, and the rotor is rotated by causing current to flow at optimum timings.

### SUMMARY

However, in the case of a position detection means using a Hall sensor and a permanent magnet, weight balance adjustments and securing with respect to the rotating shaft must be made carefully. This is because the strength (robustness) of the magnet is low compared with metals such as iron, and it is difficult to increase the processing accuracy of the magnet. Accordingly, the position detection means which is configured to withstand high speed rotation may result in an increase in manufacturing cost. In addition, electronic components, such as a Hall sensor, are often not resistant to a high-temperature environment, and may not be usable under a high-temperature environment, such as around the engine of a vehicle.

Further, sensors for detecting the rotational position of a motor are often disposed in the vicinity of a magnetic circuit of the motor. Thus, the sensors tend to be influenced by a leakage magnetic flux (which may be referred to as “leakage magnetic flux” or “linking magnetic flux”) from the magnetic circuit. In particular, the leakage magnetic flux from a motor varies over time and therefore causes an induced voltage in the sensor coils. The induced voltage may produce noise which is superimposed on a sensor output, resulting in an erroneous detection by the sensor. In addition to the leakage magnetic flux from the motor, if the sensor is disposed near a device in which a large current flows, a magnetic flux from the device may pose a disturbance which may cause an erroneous detection by the sensor.

The present invention has been made in view of the above problem, and an object of the present invention is to enable detection of the rotational position of a rotor relative to a stator, using a position sensor in which no permanent magnet is used. An object of a motor according to the present invention is to exploit the advantage of being magnet-less by detecting the rotational position by means of a position sensor in which no permanent magnet is used. The above objects are not limited and another object of the present invention is to provide operations or effects which are derived by the configurations illustrated in the embodiments described below, and which are not obtained with conventional techniques.

### SUMMARY

(1) A position sensor disclosed herein is a position sensor for detecting a rotational position, relative to a stator, of a rotor fixed to a shaft, based on a change in inductance due to rotation of the rotor, the position sensor including: the stator, which is formed in a tubular shape and disposed concentrically with a center of rotation of the shaft, the stator including a plurality of sets of magnetic pole pairs each having a pair of main magnetic poles protruding from an inner peripheral surface toward the center of rotation, the main magnetic poles opposing each other; the rotor, which includes at least a pair of protruding poles protruding radially outward from a reference cylindrical surface at a constant distance from the center of rotation; and a coil pair connected to a direct-current power supply, and comprising coils wound on the respective main magnetic poles of the magnetic pole pair of each set. The stator includes auxiliary magnetic poles positioned on both sides circumferentially of each of the main magnetic poles, and protruding radially inward from the inner peripheral surface. The two coils of the coil pair have the same winding direction when the main magnetic poles are viewed from the center of rotation.

(2) Preferably, each of the auxiliary magnetic poles may be disposed between two circumferentially adjacent main magnetic poles.

(3) Preferably, the circumferentially adjacent main magnetic poles and the auxiliary magnetic poles may be disposed at equal intervals.

(4) Preferably, the rotor may have an outer peripheral surface having an air gap from the main magnetic poles, the air gap being the same as an air gap between the outer peripheral surface of the rotor and the auxiliary magnetic poles.

(5) Preferably, the rotor may be formed from a magnetic material other than permanent magnet.

(6) A motor disclosed herein includes: the position sensor according to any one of (1) to (5); a motor rotor integrally rotating with the shaft and having no permanent magnet; and a motor stator fixed to a housing and having no permanent magnet.

According to the position sensor of the present disclosure, it becomes possible to detect a rotor rotational position relative to a stator with high accuracy, using a rotor having no permanent magnet.

Further, with the motor of the present disclosure, it becomes possible to exploit the advantages of being magnet-less by detecting the rotational position using a position sensor using no permanent magnet.

### BRIEF DESCRIPTION OF THE DRAWINGS

FIG. 1 is a schematic diagram of a magnetic circuit portion of a position sensor according to an embodiment as viewed from an axial direction;

FIG. 2 is a diagram illustrating an electric circuit portion of the position sensor of FIG. 1;

FIG. 3A is a diagram for describing the flow of magnetic flux generated in the magnetic circuit portion of FIG. 1;

FIG. 3B is a diagram for describing the flow of magnetic flux when auxiliary magnetic poles are removed from the magnetic circuit portion of FIG. 1;

FIG. 4 is a diagram illustrating inductance that changes due to rotation of the rotor, shunt voltages that change due to switching, and the contents of signal processing performed in a processing unit, in a mechanical angle range of 90 degrees.

FIG. 5 is a schematic exploded perspective view of a motor according to an embodiment;

FIG. 6 is a schematic diagram of a magnetic circuit portion of a position sensor according to a first modification, as viewed from an axial direction;

FIG. 7 is a schematic diagram of a magnetic circuit portion of a position sensor according to a second modification, as viewed from an axial direction; and

FIG. 8 is a diagram illustrating an electric circuit portion of the position sensor illustrated in FIG. 7.

### DESCRIPTION OF THE EMBODIMENTS

With reference to the drawings, a position sensor and a motor according to embodiments will be described. The embodiments which will be described below are merely exemplary, and are not intended to exclude the application of various modifications or techniques not explicitly described in the embodiments. The various configurations of the embodiments may be implemented with modifications without departing from the scope and spirit of the embodiments. Various configurations may be optionally selected or combined, as appropriate.

### 1. Configuration

FIG. 1 is a schematic diagram of a position sensor 1 according to an embodiment, as viewed from an axial direction (axial view) of a shaft 5 (rotating shaft). In the present embodiment, the position sensor 1 does not include a permanent magnet. The rotational position of a rotor 2 (hereafter referred to as “rotor position”) relative to a stator 3 is detected from a variation in an inductance L due to the rotation of the rotor 2, which is fixed to the shaft 5.

In the present embodiment, the position sensor 1 outputs two pulses for each rotation of the rotor 2 (i.e., during the mechanical angle of 360 degrees). That is, in the present embodiment, the position sensor 1 detects (identifies) whether, among the ranges at 90-degrees intervals obtained by dividing the 360-degrees mechanical angle into four equal parts (such as the four ranges of 0 to 90 degrees; 90 to 180 degrees; 180 to 270 degrees; and 270 to 360 degrees), the rotor position is in the first and third ranges (0 to 90 degrees and 180 to 270 degrees) or in the second and fourth ranges (90 to 180 degrees and 270 to 360 degrees). It is to be noted, however, that the number of pulses per rotation of the rotor 2 is not limited to two. Relevant modifications will be described later.

The position sensor 1 is incorporated into a motor 9 illustrated in FIG. 5, for example. The motor 9 is a switched reluctance motor (“SR motor 9”) that does not include a permanent magnet. The motor 9 includes a motor stator 9A fixed to a housing, which is not illustrated, and a motor rotor 9B which rotates integrally with the shaft 5. In FIG. 4, the rotor 2 and the stator 3 of the position sensor 1 are illustrated in an exploded view, and the motor stator 9A and the motor rotor 9B of the SR motor 9 are also illustrated in an exploded view. The motor stator 9A has four motor teeth portions 9C. On each of the motor teeth portions 9C, a motor coil 9E is wound via an insulator 9D.

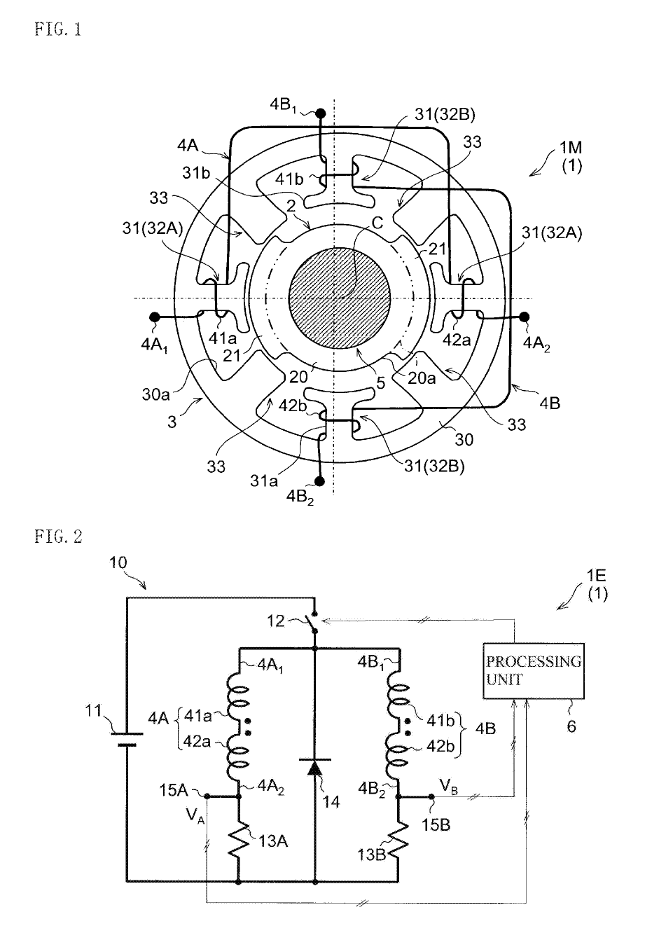

The position sensor 1 is disposed on the shaft 5 of the SR motor 9. The stator 3 is fixed to the housing, and the rotor 2 is fixed to the shaft 5. The position sensor 1 includes a magnetic circuit portion 1M illustrated in FIG. 1, and an electric circuit portion 1E illustrated in FIG. 2. The position sensor 1 detects the rotational position (motor rotation angle) of the SR motor 9 by detecting the rotor position. The magnetic circuit portion 1M includes the rotor 2, the stator 3, and two sets of coil pairs 4A, 4B. The electric circuit portion 1E includes a processing unit 6 and an excitation circuit 10. As will be described later, the coil pairs 4A, 4B are elements that are also included in the excitation circuit 10. In the present embodiment, the rotor 2 is formed from a magnetic material other than permanent magnet (for example, from ferromagnetic and soft magnetic material, such as ferrosilicon or soft ferrite). The magnetic material may be ferromagnetic and soft magnetic.

As illustrated in FIG. 1, the rotor 2 includes a cylindrical portion 20 with a constant distance from the center of rotation C of the shaft 5, and a pair of protruding poles 21 protruding radially outward from a reference cylindrical surface 20a of the cylindrical portion 20. The pair of protruding poles 21 has an identical shape, and is circumferentially displaced from each other by 180 degrees. In the present embodiment, the protruding poles 21 have an arc-shape along the reference cylindrical surface 20a in an axial view. The protruding poles 21 have corner portions at the circumferential ends thereof. The shape of the protruding poles 21 is not limited to the shape illustrated in FIG. 1. In the SR motor 9 of the present embodiment, as illustrated in FIG. 5, the rotor 2 and the motor rotor 9B are fixed to the same shaft 5, and are disposed such that the protruding poles 21 of the rotor 2 and protruding poles 91 of the motor rotor 9B are rotated while maintaining a phase difference. That is, the SR motor 9 of the present embodiment is a two-phase SR motor having a pair of protruding poles 91.

As illustrated in FIG. 1, the stator 3 is formed in an annular (tubular) shape, and is disposed concentrically with the center of rotation C of the shaft 5. In the present embodiment, the stator 3 includes: a tube portion 30 having a ring-shape in axial view; a plurality of main magnetic poles 31 protruding from an inner peripheral surface 30a of the tube portion 30 toward the center of rotation C (i.e., radially inward); and auxiliary magnetic poles 33 disposed on both sides circumferentially of the respective main magnetic poles 31. A pair of main magnetic poles 31 disposed opposing each other constitutes one magnetic pole pair 32. In the present embodiment, the stator 3 has two sets of magnetic pole pairs 32 circumferentially displaced from each other by 90 degrees, by way of example. In the following, one of the two sets of magnetic pole pairs 32 will be referred to as a first magnetic pole pair 32A, and the other as a second magnetic pole pair 32B. All of the four main magnetic poles 31 are formed in an identical shape.

In the present embodiment, the two sets of magnetic pole pairs 32A, 32B are disposed 90 degrees out of phase from each other. That is, the stator 3 has the four main magnetic poles 31 of the identical shape which are circumferentially displaced from each other by 90 degrees (i.e., at regular intervals). Each of the main magnetic poles 31 includes a tooth 31a radially extending from the inner peripheral surface 30a of stator 3, and a wall portion (hereafter referred to as “fin 31b”) provided at the radially inner end of the tooth 31a and expanding in a fin shape. Thus, the main magnetic poles 31 are substantially T-shaped in axial view. The teeth surface and the coil pairs 4A, 4B are electrically insulated from each other by means of an insulator (not illustrated).

The auxiliary magnetic poles 33 protrude from the inner peripheral surface 30a of the tube portion 30 toward the center of rotation C. In the present embodiment, the auxiliary magnetic poles 33 are each disposed between circumferentially adjacent two main magnetic poles 31. That is, the stator 3 includes the four main magnetic poles 31 and the four auxiliary magnetic poles 33 which are circumferentially alternately disposed. The circumferentially adjacent main magnetic poles 31 and the auxiliary magnetic poles 33 are disposed at equal intervals. An air gap between the outer peripheral surface of the rotor 2 and the main magnetic poles 31, and an air gap between the outer peripheral surface of the rotor 2 and the auxiliary magnetic poles 33 are the same. In other words, the four main magnetic poles 31 and the four auxiliary magnetic poles 33 have the same length of protrusion from the inner peripheral surface 30a. In the present embodiment, the auxiliary magnetic poles 33 do not include a fin such as the fin 31b of the main magnetic poles 31, and have a radially uniform cross section. The radially inner end face of the auxiliary magnetic poles 33 is curved so as to form a uniform interval between the inner end face and the protruding poles 21 of the rotor 2. It should be noted that the shape of the auxiliary magnetic poles 33 is not limited to the above example, and may be a fin-like expanding shape, for example.

The two sets of coil pairs 4A, 4B are input coils to which currents are applied, and which comprise coils wound on the main magnetic poles 31 of the respective magnetic pole pairs 32A, 32B. Specifically, one set of coil pair 4A (which may be hereafter referred to as “the first coil pair 4A”) includes a coil 41a wound on one main magnetic pole 31 of the first magnetic pole pair 32A, and a coil 42a wound on the other main magnetic pole 31. Similarly, the second set of coil pair 4B (which may be hereafter referred to as “the second coil pair 4B) includes a coil 41b wound on one main magnetic pole 31 of the second magnetic pole pair 32B, and a coil 42b wound on the other main magnetic pole 31.

The two coils 41a, 42a of the first coil pair 4A are wound so as to form mutually opposite magnetic poles when energized. When wound continuously in a series connection, as illustrated in FIG. 1, the coils 41a, 42a have the same winding direction when the respective main magnetic poles 31 are viewed from the center of rotation C. Similarly, the two coils 41b, 42b of the second coil pair 4B have the same winding direction when the respective main magnetic poles 31 are viewed from the center of rotation C. The adjacent coils 41a, 41b may have the same winding direction or opposite winding directions. The four coils 41a, 42a, 41b, 42b have the same number of turns.

In the present embodiment, the position sensor 1 detects the rotor position during the rotation of the rotor 2, based on the magnitude relationship of the inductance L of the two sets of coil pairs 4A, 4B. Accordingly, if there is a device in which a large current flows in the vicinity of the position sensor 1, the magnetic flux from the device may pose a disturbance which may cause an erroneous detection by the position sensor 1. In the present embodiment, the position sensor 1 is incorporated into the SR motor 9. In this case, the position sensor 1 is disposed in proximity to the magnetic circuit (not illustrated) in the SR motor 9, and may therefore tend to be affected by a leakage magnetic flux from the magnetic circuit.

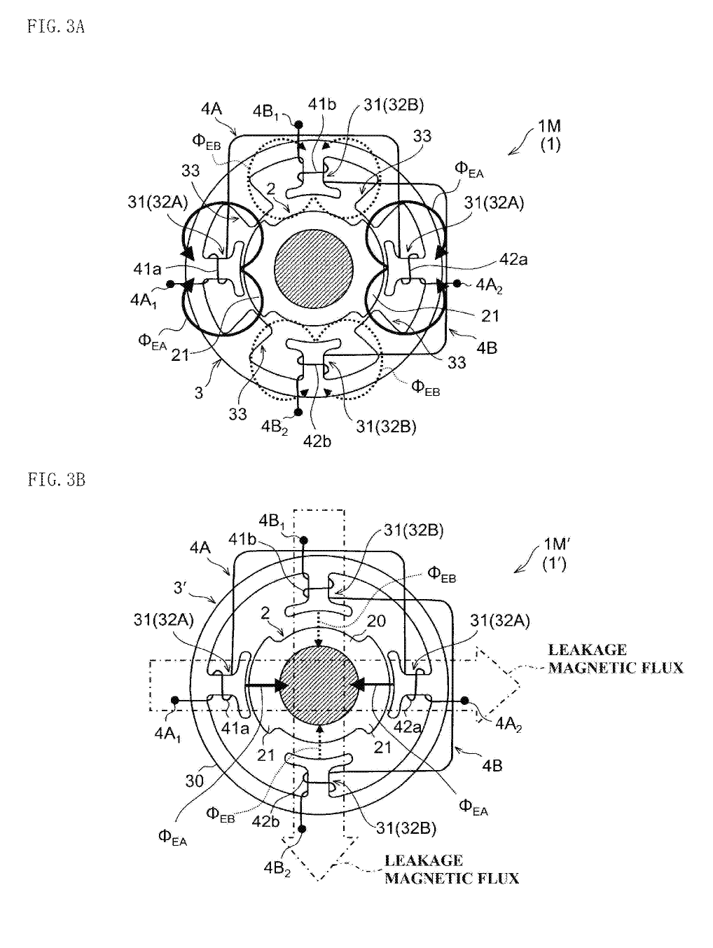

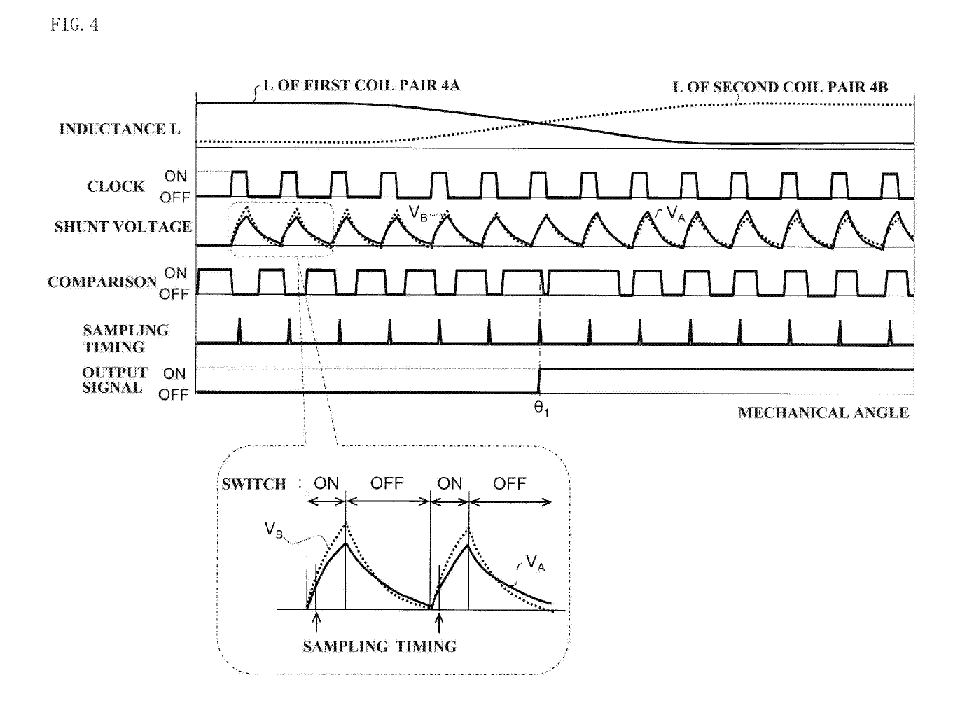

In the case of the two-phase SR motor 9, the leakage magnetic flux from the magnetic circuit can be expressed by two arrows orthogonal to each other, as indicated by dashed and single-dotted lines in FIG. 3B. FIG. 3B illustrates a position sensor 1′ (magnetic circuit portion 1M′) which differs from the position sensor 1 only in that a stator 3′ does not include the auxiliary magnetic poles 33. If the two coils of one coil pair are wound in the same direction and the two coils of the other coil pair are wound in the same direction, an induced voltage is produced in each coil due to the leakage magnetic flux that varies over time, and noise is superimposed in the value of current flowing through each coil.

If the position sensor 1′ of FIG. 3B is incorporated into the two-phase SR motor 9, while the winding directions of the opposing two coils 41a, 42a when the main magnetic poles 31 are viewed from the center of rotation C are the same, the leakage magnetic flux in the lateral direction in the figure links one coil 41a in the direction of the leakage magnetic flux toward the center of rotation C, producing a plus voltage, whereas the leakage magnetic flux links the other coil 42a in the direction away from the center of rotation C, producing a minus voltage of the same level. Thus, the plus voltage and the minus voltage cancel each other out, whereby the noise due to the leakage magnetic flux in the lateral direction is cancelled. Similarly, in the position sensor 1′, while the winding directions of the opposing two coils 41b, 42b are the same, the directions in which the linking of the leakage magnetic flux occurs are different, whereby the noise due to the leakage magnetic flux in the vertical direction in the figure is also cancelled.

However, in the position sensor 1′ illustrated in FIG. 3B, as indicated by thick arrows and dashed line arrows in FIG. 3B, magnetic fluxes Φ_{EA}, Φ_{EB} generated by excitation are also cancelled, making the sensor inoperable. That is, as indicated by the thick arrows in FIG. 3B, the direction of the magnetic flux Φ_{EA} generated in one coil 41a and the direction of the magnetic flux Φ_{EA} generated in the other coil 42a are opposite, so that the magnetic fluxes Φ_{EA} cancel each other out. Similarly, as indicated by the dashed line arrows in FIG. 3B, the magnetic flux Φ_{EB} generated in one coil 41b and the magnetic flux Φ_{EB} generated in the other coil 42b cancel each other out. As a result, a magnetic flux difference cannot be obtained between the two sets of coil pairs 4A, 4B, and no difference is caused in the inductance L between the coil pairs 4A, 4B.

In order to solve the problem, the position sensor 1 according to the present embodiment is provided with a plurality of auxiliary magnetic poles 33. The auxiliary magnetic poles 33 have the function of preventing the cancellation of the magnetic fluxes Φ_{EA}, Φ_{EB} generated in the coil 41a and the like. That is, the auxiliary magnetic poles 33 serve to provide the magnetic fluxes Φ_{EA}, Φ_{EB} generated in the coil 41a and the like with respective magnetic paths, as indicated by thick arrows and dashed line arrows in the FIG. 3A. In the present embodiment, as illustrated in FIG. 3A, the main magnetic poles 31 protrude in the directions aligned with the directions of the leakage magnetic fluxes from the SR motor 9 to which the position sensor 1 is mounted. However, the directions in which the main magnetic poles 31 protrude are not limited to the directions of the present embodiment.

The magnetic fluxes Φ_{EA} respectively generated in the coils 41a, 42a of the first coil pair 4A pass out of the fins 31b of the main magnetic poles 31 and through the rotor 2, are each divided into two and curved toward the auxiliary magnetic poles 33 on both sides, pass through the auxiliary magnetic poles 33, and return to the main magnetic poles 31 through the tube portion 30. Thus, the magnetic fluxes Φ_{EA} pass through separate magnetic paths. Likewise, the magnetic fluxes Φ_{EB} respectively generated in the coils 41b, 42b of the second coil pair 4B pass out of the fins 31b of the main magnetic poles 31 and through the rotor 2, are divided and curved toward the auxiliary magnetic poles 33 on both sides, pass through the auxiliary magnetic poles 33, and return to the main magnetic poles 31 through the tube portion 30. Thus, the magnetic fluxes Φ_{EB} pass through separate magnetic paths. In this case, when the distances between each of the two magnetic pole pairs 32A, 32B and the protruding poles 21 of the rotor 2 are different, a difference is caused between the two magnetic fluxes Φ_{EA}, Φ_{EB}. Thus, it becomes possible to determine the magnitude relationship of the inductance L between the coil pairs 4A, 4B through current changes in the coil pairs 4A, 4B.

As illustrated in FIG. 2, in the present embodiment, the excitation circuit 10 includes: a direct-current power supply 11; a switch 12; the two sets of coil pairs 4A, 4B; two resistors 13A, 13B; a diode 14; and two output terminals 15A, 15B. The switch 12 turns on or off the supply of current to the coil pairs 4A, 4B. The switch 12 is connected in series with the direct-current power supply 11. The two sets of coil pairs 4A, 4B are connected in parallel with each other, and are each connected in series with the direct-current power supply 11. The two resistors 13A, 13B are respectively connected in series with the coil pairs 4A, 4B. The diode 14 is connected in series with the direct-current power supply 11. The two output terminals 15A, 15B are respectively provided between the coil pairs 4A, 4B and the resistors 13A, 13B. In the following, when the two output terminals 15A, 15B are distinguished, one on the first coil pair 4A side will be referred to as a first output terminal 15A, and the other on the second coil pair 4B side will be referred to as a second output terminal 15B.

More specifically, one end 4A₁ of the first coil pair 4A is connected to the plus terminal of the direct-current power supply 11 via the switch 12. The other end 4A₂ of the first coil pair 4A is connected to the minus terminal of the direct-current power supply 11 via the resistor 13A. One end 4B₁ of the second coil pair 4B is connected to the plus terminal of the direct-current power supply 11 via the switch 12. The other end 4B₂ of the second coil pair 4B is connected to the minus terminal of the direct-current power supply 11 via the resistor 13B. When the switch 12 is on, current flows through both of the coil pairs 4A, 4B, and it becomes possible to detect voltage values V_{A}, V_{B} across the resistors 13A, 13B, respectively, at the output terminals 15A, 15B, respectively. In the following, when the two voltage values V_{A}, V_{B} are distinguished, the value on the first output terminal 15A side may be referred to as a first voltage value V_{A}, and the value on the second output terminal 15B side may be referred to as a second voltage value V_{B}.

A processing unit 6 performs the process of switching of the switch 12 at high frequency during rotation of the rotor 2, and detecting the rotor position relative to the stator 3 based on the magnitude relationship of the inductance L between the two sets of coil pairs 4A, 4B. The processing unit 6 includes a signal processing circuit, for example. The switching frequency is set to be sufficiently higher than at least the rotational speed of the rotor 2, and is 50 kHz, for example. In the present embodiment, the processing unit 6 acquires the voltage values V_{A}, V_{B} across the resistors 13A, 13B from the respective output terminals 15A, 15B, instead of the inductance L of each of the coil pairs 4A, 4B. The processing unit 6 then processes the voltage values V_{A}, V_{B} and converts them into output signals (pulse signals).

FIG. 4 is a diagram illustrating the inductance L varying due to the rotation of the rotor 2, and the voltage values V_{A}, V_{B} (shunt voltages) varying due to the switching, together with the contents of signal processing performed by the processing unit 6, in a mechanical angle range of 90 degrees. In FIG. 4, the horizontal axis shows the mechanical angle of the rotor 2. FIG. 4 illustrates: the inductance L varying in the mechanical angle range of 90 degrees; a clock (on-off signal) input to the switch 12; the voltage values V_{A}, V_{B} (shunt voltages); the result of comparison of the magnitudes of the two voltage values V_{A}, V_{B}; sampling timing; and output signal. Of the waveforms (voltage waveforms) indicating the variation s in the inductance L and the voltage values V_{A}, V_{B}, the solid lines correspond to the first coil pair 4A and the dashed line corresponds to the second coil pair 4B. In FIG. 4, a part of the voltage waveforms is shown as enlarged by way of example, as indicated by dashed and single-dotted lines.

As the rotor 2 rotates, the distance between the magnetic pole pairs 32A, 32B and the outer peripheral surface of the rotor 2 changes. For example, when the rotor position is in the state illustrated in FIG. 1, the distance between the first magnetic pole pair 32A and the outer peripheral surface of the rotor 2 becomes smaller than the distance between the second magnetic pole pair 32B and the outer peripheral surface of the rotor 2 by the protrusion of the protruding poles 21. Accordingly, the magnetic resistance of the first coil pair 4A becomes smaller than the magnetic resistance of the second coil pair 4B. As a result, as illustrated in FIG. 3A, the amount of magnetic flux generated by excitation becomes greater for the first coil pair 4A than for the second coil pair 4B. That is, in the case of the rotor position illustrated in FIG. 1 and FIG. 3A, the inductance L of the first coil pair 4A is greater than that of the second coil pair 4B. When the switch 12 is turned on in this state, the current rises more slowly in the first coil pair 4A with the greater inductance L than in the second coil pair 4B.

As the rotor 2 rotates by more than 45 degrees from the state of FIG. 1 and FIG. 3A, the protruding poles 21 are separated from the first magnetic pole pair 32A and become closer to the second magnetic pole pair 32B. Thus, the amount of magnetic flux generated by excitation becomes smaller for the first coil pair 4A than for the second coil pair 4B. As a result, the inductance L of the first coil pair 4A becomes smaller than that of the second coil pair 4B. Accordingly, when the switch 12 is turned on in this state, the current rises more quickly in the first coil pair 4A with the smaller inductance L than in the second coil pair 4B.

That is, the outer peripheral surface of the rotor 2 is closer to the magnetic pole pair 32A or 32B having wound thereon one of the two sets of coil pairs 4A, 4B that has a smaller current value when the switch 12 is in on-state. Accordingly, by repeating the turning on and off of the switch 12 at high speed and comparing the magnitudes of the current values of the two sets of coil pairs 4A, 4B at an arbitrary timing when the switch 12 is on, it becomes possible to determine the position of the protruding poles 21 of the rotor 2 (i.e., rotor position). In the present embodiment, the excitation circuit 10, as indicated by solid lines and dashed lines in FIG. 4, outputs the voltage values V_{A}, V_{B} respectively across the resistors 13A, 13B from the respective output terminals 15A, 15B instead of current values. Thus, the processing unit 6 compares the magnitudes of the voltage values V_{A}, V_{B}.

The inductance L has characteristics such that, as indicated by a solid line and a dashed line in FIG. 4, when the inductance L of one is greater, the inductance of the other is smaller; as the inductance L of one begins to decrease, the inductance L of the other begins to increase, and the magnitude relationship is reversed at a certain angle. The position (mechanical angle) at which the reversal of the magnitude relationship of the inductance L occurs is the position reached by a 45-degree rotation from the rotor position of FIG. 1 and FIG. 3A; i.e., the mechanical angle when the protruding poles 21 are disposed opposite the auxiliary magnetic poles 33 each at the center of circumferentially adjacent two magnetic poles 31. The processing unit 6, instead of directly detecting the change (characteristic) in the inductance L, performs the processing described above to convert voltage waveforms into output signals and to thereby detect (identify) the rotor position.

As illustrated in FIG. 4, the processing unit 6 inputs to the switch 12 a clock signal repeating on and off states at predetermined cycles (such as 50 kHz). That is, when the clock is on, the switch 12 turns on, current flows through the coil pairs 4A, 4B and voltages are output from the output terminals 15A, 15B. In this case, the rise of the voltage (current) is determined by the inductance L of the coil pairs 4A, 4B. For example, when the inductance L of the first coil pair 4A is greater, the rise of the voltage when the clock (switch 12) is on is quicker for the second voltage value V_{B} than for the first voltage value V_{A} (i.e., the second voltage value V_{B} has a steeper slope), as shown enlarged in the figure.

The processing unit 6 acquires the comparison waveforms (on/off signals for comparison) illustrated in FIG. 3 by inputting the two voltage values V_{A}, V_{B} to a comparator (not illustrated). In the present embodiment, the comparator outputs an on-signal when the first voltage value V_{A}≥the second voltage value V_{B}, and outputs an off-signal when the first voltage value V_{A}<the second voltage value V_{B}. Alternatively, the comparator may be configured to output an off-signal when the first voltage value V_{A}≥the second voltage value V_{B}, and to output an on-signal when the first voltage value V_{A}<the second voltage value V_{B}. The sampling timing is a signal for determining the timing of extraction of the on/off signals for comparison, and is synchronized with the clock. The sampling timing may be aligned with the instant of switching of the clock from off to on, or from on to off, for example. Alternatively, the sampling timing may be an arbitrary timing, such as several microseconds after the instant of switching.

The processing unit 6 extracts the on/off signals for comparison at the sampling timing synchronized with the clock, and outputs output signals of the same on-off states as the on-signal and off-signal for comparison. That is, the processing unit 6 outputs an on-output signal when the comparison is on-signal, and outputs an off-output signal when the comparison is off-signal. In the example illustrated in FIG. 4, the output signal switches from off to on at the mechanical angle θ₁ when the two voltage waveforms are substantially overlapping. The switch timing (i.e., the mechanical angle θ₁) is an angle at which the magnitude relationship of the inductance L is reversed, and which, in the present embodiment, is a position rotated from the rotor position of FIG. 1 and FIG. 3A by 45 degrees. While FIG. 4 only illustrates the mechanical angle range of 90 degrees, output signals similar to those of FIG. 4 are output in each of the ranges of 90 to 180 degrees, 180 to 270 degrees, and 270 to 360 degrees. Thus, even when the inductance L cannot be directly detected, the magnitude relationship of the inductance L can be determined from voltage waveforms, making it possible to detect (identify) the rotor position.

The rotor 2 of the position sensor 1 and the motor rotor 9B of the SR motor 9 are both fixed to the shaft 5 in a non-rotatable manner. Accordingly, the rotor position can be detected (identified) based on the output signal (on or off) output from the processing unit 6. It further becomes possible to implement current control to cause the motor rotor 9B to rotate based on the output signal (or rotor position information).

### 2. Effects

(1) In the position sensor 1, the first coil pair 4A comprises the coils 41a, 42a wound in the same direction, and the second coil pair 4B comprises the coils 41b, 42b wound in the same direction. Accordingly, the influence of disturbance can be cancelled. For example, even if a plus voltage is generated in one coil (such as coils 41a, 41b) due to a leakage magnetic flux from the SR motor 9, the plus voltage can be cancelled by a minus voltage of the same level generated in the other coil (such as the coils 42a, 42b).

In addition, the position sensor 1 is provided with the auxiliary magnetic poles 33. Accordingly, the magnetic flux Φ_{EA} generated in the coils 41a, 42a and the magnetic flux Φ_{EB} generated in the coils 41b, 42b pass separate magnetic paths without cancelling each other out. Thus, it is possible to detect the rotor position based on the magnitude relationship of the inductance L through a current change due to a magnetic flux difference between the two sets of coil pairs 4A, 4B (i.e., a difference in the inductance L of the coil pairs 4A, 4B). Accordingly, with the position sensor 1, it becomes possible to detect the rotor position relative to the stator 3 with high accuracy, using the rotor 2 having no permanent magnet

In addition, with the position sensor 1, the rotor position can be detected by phase comparison. Accordingly, even when the voltage of the direct-current power supply 11 is varied, for example, detection accuracy can be maintained. Further, with the position sensor 1, the configuration of the magnetic circuit portion 1M and the configuration of the electric circuit portion 1E can be simplified.

(2) In the position sensor 1, each of the auxiliary magnetic poles 33 is disposed between circumferentially adjacent two main magnetic poles 31. Thus, each auxiliary magnetic pole 33 positioned in-between is shared by the circumferentially adjacent two main magnetic poles 31. Accordingly, the configuration of the stator 3 (position sensor 1) can be simplified.

(3) Further, in the position sensor 1, the circumferentially adjacent main magnetic poles 31 and the auxiliary magnetic poles 33 are disposed at equal intervals. This makes it easier to obtain the effect of cancelling the leakage magnetic flux. In addition, the configuration facilitates designing, makes it easier to wind the coil 41a and the like, and improves productivity.

(4) With the position sensor 1, since the main magnetic poles 31 and the auxiliary magnetic poles 33 have the same air gap, designing becomes easier and productivity can be improved.

(5) When the rotor 2 is formed from a magnetic material other than permanent magnet, as in the position sensor 1, inexpensive and relatively easy-to-process material, such as ferrosilicon, can be used, whereby the cost of the rotor 2 can be reduced.

(6) The position sensor 1 does not use permanent magnet. Accordingly, by detecting the rotational position using the position sensor 1, the advantages of the SR motor 9, such as high robustness and heat resistance, can be exploited. In addition, with the SR motor 9, the position sensor 1 can maintain detection accuracy regardless of any voltage variation in the direct-current power supply 11, as described above.

Accordingly, stable current control for rotating the motor rotor 9B can be implemented.

### 3. Others

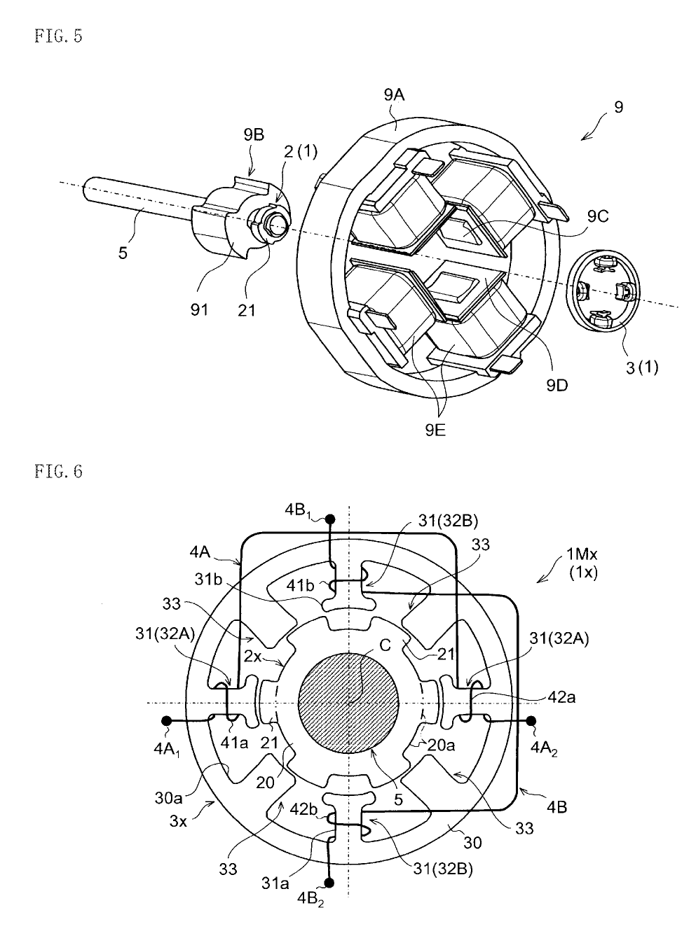

While the embodiment has been described with reference to the example in which the position sensor 1 outputs two pulses per rotation, the configuration of the position sensor 1 is not limited to the example. In another example, as illustrated in FIG. 6, a position sensor 1x may be provided with a rotor 2x having three sets of a pair of protruding poles 21. The position sensor 1x (magnetic circuit portion 1Mx) of FIG. 6 differs from the position sensor 1 of the foregoing embodiment in the shape of the rotor 2x and the length of fins 31b of a stator 3x in the rotational direction. The position sensor 1x is identical to the position sensor 1 in other configurations (such as the configuration of the excitation circuit 10, and the contents of processing in the processing unit 6).

In the position sensor 1x, the six protruding poles 21 of an identical shape are displaced from each other by 60 degrees in the circumferential direction of the rotor 2x. The fins 31b of the magnetic poles 31 of the stator 3x have a rotational direction length which is approximately the same as a rotational direction length of the protruding poles 21 of the rotor 2x. When the rotational direction length of the fins 31b is increased, the variation of the inductance L is decreased. Accordingly, it may be desirable that the fins 31b and the protruding poles 21 have a length relationship such that, when the central position of one of the fins 31b and the central position of one of the protruding poles 21 are aligned, the ends in the rotational direction of the fin 31b are not greater than one-fourth the recess between the protruding poles 21b.

With the position sensor 1x, the magnitude relationship of the inductance L of the two sets of coil pairs 4A, 4B are reversed at cycles (mechanical angle) shorter than those in the foregoing embodiment. Because the position sensor 1x outputs six pulses per rotation, it is possible to identify the rotor position at 30-degrees intervals corresponding to 12 equal parts of the 360-degrees mechanical angle. Thus, with the position sensor 1x according to the present modification, it is possible to obtain similar effects from a configuration similar to that of the foregoing embodiment. Further, with the position sensor 1x where the number of protruding poles of the rotor 2x is increased, it is possible to control a motor in which the rotor position needs to be identified at finer angular intervals.

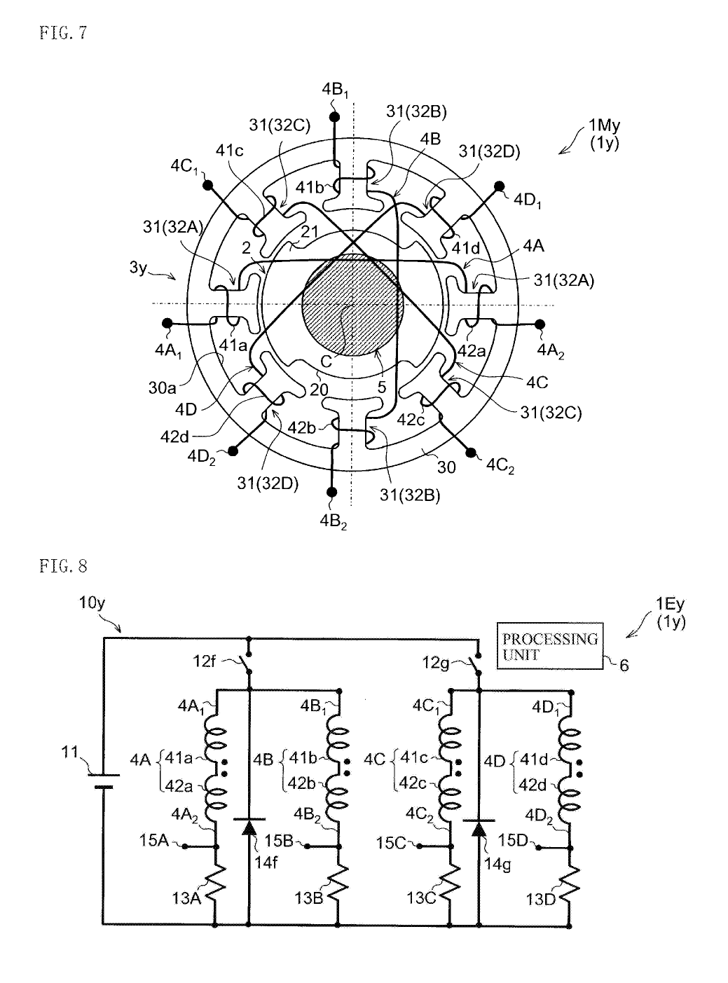

As illustrated in FIG. 7, for example, a position sensor 1y may be provided with main magnetic poles 31 having coils wound thereon at the positions corresponding to the auxiliary magnetic poles 33, the position sensor 1y configured to provide functions similar to those of the position sensor 1 by means of an electric circuit portion 1Ey. The position sensor 1y (magnetic circuit portion 1My) illustrated in FIG. 7 includes a stator 3y provided with four sets of the magnetic pole pairs 32 each comprising a pair of main magnetic poles 31. That is, the stator 3y includes four sets of magnetic pole pairs 32A, 32B, 32C, 32D circumferentially displaced from each other by 45 degrees, and four sets of coil pairs 4A, 4B, 4C, 4D. The coil pairs 4A to 4D respectively comprise coils 41a and 42a, coils 41b and 42b, coils 41c and 42c, and coils 41d and 42d, which are respectively wound on the main magnetic poles 31 of the respective magnetic pole pairs 32A to 32D. The position sensor 1y of FIG. 7 is provided with the same rotor 2 of an earlier embodiment.

FIG. 8 illustrates an example of the electric circuit portion 1Ey of the position sensor 1y of FIG. 7. In FIG. 8, signal lines are omitted. In an excitation circuit 10y of the electric circuit portion 1Ey of FIG. 8, the two sets of coil pairs 4A, 4B displaced from each other by 90 degrees are provided with a switch 12f and a diode 14f, and the two sets of coil pairs 4C, 4D displaced from each other by 90 degrees are provided with a 12g and a diode 14g. The switch 12f and the switch 12g are connected in parallel. The switch 12f is used to switch the on/off of current that flows through the coil pairs 4A and 4B. The switch 12g is used to switch the on/off of current that flows through the coil pairs 4C and 4D. The diodes 14f, 14g are respectively connected in series with the switches 12f, 12g. In the excitation circuit 10Ey, when only one of the two switches 12f, 12g is on, current flows only through one of the two sets of coil pairs 4A, 4B or the two sets of coil pairs 4C, 4D.

In the position sensor 1y provided with the excitation circuit 10y, by allowing current to flow only through one of the two sets of coil pairs 4A, 4B or the two sets of coil pairs 4C, 4D for excitation, the other through which no current flows functions as the auxiliary magnetic poles 33. Accordingly, with the position sensor 1y illustrated in FIG. 7 and FIG. 8, it is also possible to obtain effects similar to those of the foregoing embodiments in a similar configuration.

In the foregoing embodiments, the processing unit 6 implements both the switching of the switches 12, 12f, 12g and the signal processing based on the output voltage values. However, this is merely by way of example, and the functions of the processing unit 6 (switching and signal processing) may be divided into two elements. The switching frequency of the switch 12 is not limited to 50 kHz. Preferably, the switching frequency may be set, based on an upper limit value of the operating rotational speed of the motor (upper limit rotational speed) and the electric angle per mechanical angle 360° of the motor, such that “switching frequency≥(upper limit rotational speed/60)×(electric angle/360)×5”.

The configurations of the excitation circuits 10, 10y are merely examples and are not limited to those mentioned above. For example, the current values may be detected by omitting the resistor 13A and the like, or more than one switch 12 may be used. While in FIG. 1 and FIG. 2, the coil 41a and the coil 42a, and the coil 41b and the coil 42b are respectively connected in series, they may be connected in parallel. In a parallel configuration, the absolute values of the inductance L of the coil pairs 4A, 4B may be changed, and the current that flows through a phase may increase. However, the magnitude relationship of the inductance L between the coil pairs 4A, 4B does not change, so that the same outputs as in the case of the series connection can be obtained. The relationship also applies to the cases of FIG. 6 and FIG. 7.

The shapes of the rotors 2, 2x and the stators 3, 3y of the foregoing embodiments and modifications are merely examples and are not limited to those mentioned above. As long as the rotor has at least a pair of protruding poles protruding radially outward from the reference cylindrical surface at a constant distance from the center of rotation, the rotor may have any shape, such as an elliptical shape. The outer shape of the stator in axial view may not be a ring-shape but a shape with an angular portion (such as a rectangle or an octagon). The direction of protrusion of the main magnetic poles 31 may be set independently of the direction of the leakage magnetic flux from the SR motor 9. The radial length of the main magnetic poles 31 and the radial length of the auxiliary magnetic poles 33 may be different from each other. Not all of the intervals between the circumferentially adjacent main magnetic poles 31 and the auxiliary magnetic poles 33 may be the same. As long as the auxiliary magnetic poles 33 are provided on both sides circumferentially between the main magnetic poles 31, two or more auxiliary magnetic poles 33 may be provided between circumferentially adjacent main magnetic poles 31. The position sensors 1, 1x, 1y may not be dedicated for the SR motor 9, but may be provided in a brushless motor other than the SR motor 9, or in a generator, for example.

1. A position sensor for detecting a rotational position, relative to a stator, of a rotor fixed to a shaft, based on a change in inductance due to rotation of the rotor, the position sensor comprising:
the stator, which is formed in a tubular shape and disposed concentrically with a center of rotation of the shaft, the stator including a plurality of sets of magnetic pole pairs each comprising a pair of main magnetic poles protruding from an inner peripheral surface toward the center of rotation, the main magnetic poles opposing each other;
the rotor, which includes at least a pair of protruding poles protruding radially outward from a reference cylindrical surface at a constant distance from the center of rotation; and
a coil pair connected to a direct-current power supply, and comprising coils wound on the respective main magnetic poles of the magnetic pole pair of each set,
wherein:
the stator includes auxiliary magnetic poles positioned on both sides circumferentially of each of the main magnetic poles, and protruding radially inward from the inner peripheral surface; and
the two coils of the coil pair have the same winding direction when the main magnetic poles are viewed from the center of rotation.

2. The position sensor according to claim 1, wherein each of the auxiliary magnetic poles is disposed between two circumferentially adjacent main magnetic poles.

3. The position sensor according to claim 2, wherein the circumferentially adjacent main magnetic poles and the auxiliary magnetic poles are disposed at equal intervals.

4. The position sensor according to claim 1, wherein the rotor has an outer peripheral surface having an air gap from the main magnetic poles, the air gap being the same as an air gap between the outer peripheral surface of the rotor and the auxiliary magnetic poles.

5. The position sensor according to claim 1, wherein the rotor is formed from a magnetic material other than permanent magnet.

6. A motor comprising:
the position sensor according to claim 1;
a motor rotor integrally rotating with the shaft and having no permanent magnet; and
a motor stator fixed to a housing and having no permanent magnet.
